(19) United States
(12) Patent Application Publication
(10) Pub. No.: US 2009/0277072 A1
(43) Pub. Date: Nov. 12, 2009

(54) ARTICULATED FISHING FLY

(76) Inventor: Derek Fergus, Salem, OR (US)

Correspondence Address: Bruce E. Harang, PO BOX 872735, VANCOUVER, WA, 98687-2735, US

(21) Appl. No.: 12/116,856

(22) Filed: May 7, 2008

(51) Int. Cl. A01K 85/08

(52) U.S. Cl. 43/42.25

(57) ABSTRACT

This invention relates to an articulated fishing fly lure having a flexible body portion. The body portion being a flexible strength bearing element to which are permanently attached fly tying materials comprising free natural fibers without a hide or stem. Another embodiment comprises body sections of both natural fibers free of hide or stem and synthetic fibers. This invention further relates to the method of producing said articulated fishing fly lure.

### BACKGROUND OF THE INVENTION

1. Field of the Invention

The present invention generally relates to an articulated fishing fly having great mobility and “breathing movement” in the water while also being easy to construct.

2. Description of the Related Art

It has long been a desire to provide life like appearance in artificial lures by providing movement to simulate or suggest life in said artificial lures. This movement to suggest life effect may be produced in lures that are actively retrieved by providing jointed bodies or soft flexible bodies that undulate when actively retrieved. For example, U.S. Pat. No. 6,154,999 to Woods issued Dec. 5, 2000 teaches the use of a generally flat flexible fabric material for use as a tail on a weighted jig hook.

Another method of providing movement is by the use of elongated fishing flies that comprise a hook at the rear of the fly and a hook eye portion of a fly line attachment element at the front of the fly connected by flexible material. This provides movement and a hook that has a short shank to help prevent the fish from using the hook shank to leverage the hook out of its mouth during the ensuing fight. For example, U.S. Pat. No. 4,967,505 to Wulff issued Nov. 6, 1990 discloses the use of a metal wire trace having a metal eye on both ends of the trace. One eye is used as the front of the fly to attach to the fishing line and the other eye is used as the rear end of the fly to which is attached a short shank hook. The fly body is tied to a head portion that is moveably threaded on the metal trace between the two metal eyes. Additional body material may be tied to the hook shank but there is no teaching of tying the body directly to the metal trace itself.

Yet another method of providing movement in the fishing lure is in U.S. Pat. No. 5,084,997 to DiPaola issued Feb. 4, 1992 disclosing a specially designed premade body material wrapped around the flexible strength bearing element of an articulated fly having a loop formed at both ends of the flexible bearing element upon which the premade body is wrapped. The premade body is designed to provide a predetermined bait fish body shape with movement provided by the flexible cord. There is also a teaching of the body material providing some additional movement but this is limited by the constraints of the material being rigid enough to allow for manipulation of the body material to take and hold a desired shape.

A further method of providing this life like movement especially when using a classic downstream swing or a dead drift fly fishing technique without any active retrieve is provided by the use of highly mobile materials tied around a flexible cord. Materials like marabou fibers and soft hair such as rabbit and Arctic fox furs. Typically, these types of fishing lures, commonly called articulated flies, require that the fur be in strips on the hide have one end lashed to the hook shank in the rear and then are wrapped around the flexible element and lashed down to the front eye portion of another hook or metal eyelet such as a cotter pin. Likewise, the marabou is wrapped around the hook shanks and flexible strength bearing element as a full feather including the shaft or rachis. Alternatively materials like marabou are lashed to the front metal eyelet and wrapped on this portion of the lure only using the length of the marabou fibers to hide the flexible element and the rear hook.

However, in fishing using a classic downstream swing or a dead drift presentation of a fly with a fly rod and fly line where there is no active retrieve these solutions simply do not provide the movement necessary to suggest life through movement of the body materials. A fishing fly lure that does not require lashing of the material to the rear hook before applying the material to the flexible element while maintaining the flexibility of both the materials and the flexible strength bearing element and further which provides durability and ease and speed of construction. Additionally, there is still a need for providing an articulated flexible body which itself is covered with highly mobile material and not depend solely on such material being applied to the front eye portion of the fly lure only.

### DISCLOSURE OF THE INVENTION

The present invention provides advantages and alternatives over the prior art by providing an articulated fishing fly lure having a body composed of very mobile natural material fibers mounted onto a flexible strength bearing element that does not require the very mobile natural material fibers be on the hide or a stem.

According to a further aspect of the present invention, there is provided an articulated fishing fly utilizing more than one variety or type of very mobile natural material fibers free of hide or stem attachment method directly to a flexible strength bearing element.

According to yet another aspect of the present invention there is provided an articulated fishing fly utilizing one or more kinds of very mobile natural material fibers as well as one or more very mobile synthetic materials as loose fibers producing a multi-material body.

According to a yet further aspect of the present invention there is provided a fishing lure comprising: a hook; a flexible strength bearing element having first and second terminal ends; means for attaching said hook means to said first terminal end of said flexible strength bearing element; fly line attachment element having a distal portion for attaching said flexible strength bearing element and a proximal portion for attaching said fishing lure to a fly line; means for attaching said fly line attachment element to said second terminal end of said flexible strength bearing element; and a body portion comprising a plurality of free fibers fixedly attached to said flexible strength bearing element and said distal portion of said fly line attachment element by an attachment means and said plurality of free fibers further characterized as being attached substantially completely around and extending radially from said flexible strength bearing element and said distal portion of said fly line attachment element forming a desired body shape.

According to still another aspect of the present invention there is provided a fishing lure comprising: a hook; a flexible strength bearing element having first and second terminal ends; means for attaching said hook to said first terminal end of said flexible strength bearing element; fly line attachment element having a distal portion for attaching said flexible strength bearing element and a proximal portion for attaching said fishing lure to a fly line; a weight capable of being mounted on said fly line attachment element means for attaching said fly line attachment element to said second terminal end of said flexible strength bearing element; and a body portion comprising a plurality of free fibers fixedly attached to said flexible strength bearing element and said distal portion of said fly line attachment element by an attachment means and said plurality of free fibers further characterized as being attached substantially completely around and extending radially from said flexible strength bearing element and said distal portion of said fly line attachment element forming a desired body shape.

According to yet still another aspect of the present invention there is provided a method of producing an articulated fishing fly lure that having a weighed head such as a cone head mounted on the fly line attachment element.

The present invention thus advantageously provides an articulated fishing fly lure and method of making same that eliminates the need for very mobile natural material fibers to be bound to a hide or stem base for mounting onto a flexible strength bearing element while retaining the durability and mobility of said fishing fly lure.

### BRIEF DESCRIPTION OF THE DRAWINGS

FIG. 1 shows a side view of a hook suitable for use as the articulated hook having a doubled flexible connecting flexible strength bearing element being mounted upon the hook.

FIG. 2 shows a side view of the hook of FIG. 1 with the doubled flexible strength bearing element attached to said hook.

FIG. 3 shows a side view of a fly line attachment element, preferably a hook with the bend and point having been removed, and a cone head weight mounted thereon and then an attaching means fly tying thread attached to the shank of said hook rearward of the eye and the mounted cone head weight.

FIG. 4 show a side view of the a hook of FIG. 1 and the fly line attachment element of FIG. 3 with the doubled flexible strength bearing element being mounted to said fly line attachment element to create an articulation section between said hook and said fly line attachment element.

FIG. 5 shows a side view of said fly line attachment element with the doubled flexible strength bearing element mounted by passing through the cone head weight, then through the eye of said fly line attachment element and then once again passing through the cone head weight.

FIG. 6 shows a side view of said fly line attachment element with the doubled flexible strength bearing element mounted by passing through the cone head weight, then through the eye of said fly line attachment element and then once again passing through the cone head weight and being permanently mounted to the fly line attachment element using tying thread as the attaching means.

FIG. 7 shows a side view of the a hook of FIG. 1 and the fly line attachment element of FIG. 3 with the doubled flexible strength bearing element being mounted to said fly line attachment element to create an articulation section between said hook and said fly line attachment element having the tying thread attaching means wrapped from the front to the rear of the flexible strength bearing element.

FIG. 8 shows a side view of a FIG. 7 with a first desired amount of very mobile natural fly tying material not bound to a hide or stem being mounted directly onto the flexible strength bearing element.

FIG. 9 shows FIG. 8 with the excess butts of the first desired amount of very mobile natural fly tying material removed.

FIG. 10 shows a side view of a completed very mobile natural articulated fly lure of the claimed invention comprising a desired number of desired amounts of the same or different very mobile natural material fibers.

FIG. 11 shows a side view of FIG. 9 where a very mobile synthetic fiber bound to a base material is mounted in front of the first desired amount of very mobile natural fly tying material.

FIG. 12 shows a side view of the fly of FIG. 11 where a desired amount of the synthetic fiber has been wrapped onto the flexible strength bearing element and the excess synthetic material is laid along the flexible strength bearing element towards the front of the fly.

FIG. 13 shows a side view of the fly of FIG. 12 with a second desired amount of very mobile natural material mounted in front of the first desired amount of synthetic fiber.

FIG. 14 shows a side view of the fly of FIG. 11 with the desired number of alternating sections of very mobile natural and synthetic fiber mounted on the flexible strength bearing element and fly line attachment element shank to a point slightly behind the eye or behind the eye and weight.

FIG. 15 shows a side view of the fly of FIG. 14 with a marabou plume or similar mobile fiber feather on the stem mounted in front of the last desired mobile fiber material and behind the fly line attachment element eye or fly line attachment element eye and weight.

FIG. 16 shows a side view of the fly of FIG. 15 completed and ready to fish.

### DESCRIPTION OF THE PREFERRED EMBODIMENTS OF THE INVENTION

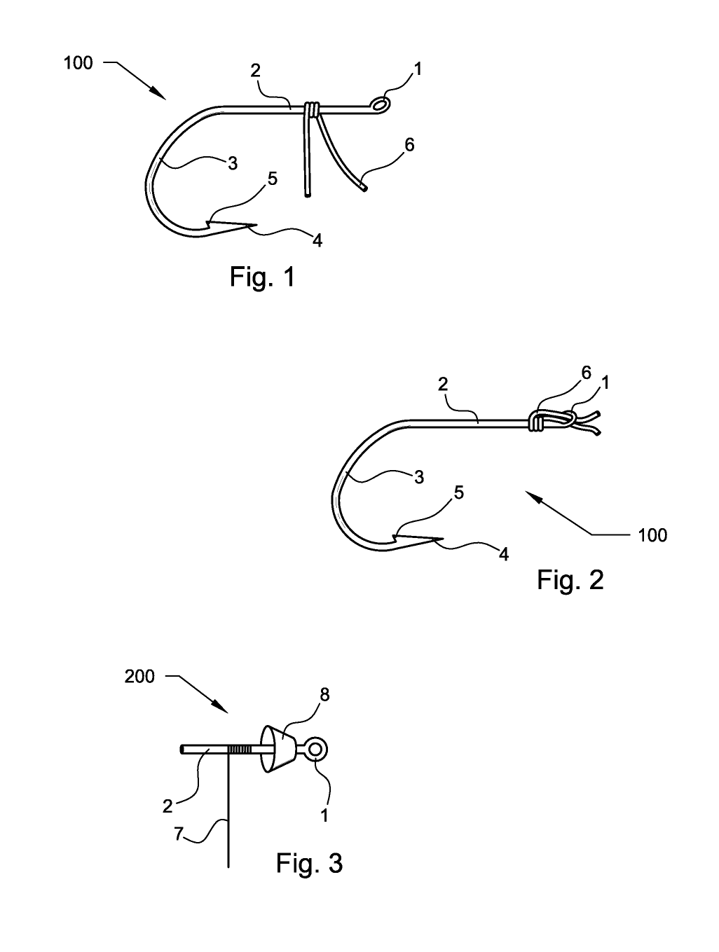

Reference will now be made to the drawings, wherein to the extent possible like reference numerals are utilized to designate like components throughout the various views. Referring to FIG. 1, there is shown a hook 100 comprising a hook eye 1, a hook shank 2 terminating in a hook bend 3 and hook point 4 optionally having a hook barb 5. As further shown in FIG. 1 a flexible strength bearing element 6 of desired length is permanently attached to the hook shank 2 of a hook 100 by making several wraps of said flexible strength bearing element 6 around said hook shank 2 behind, or rearward toward the hook bend 3, of hook eye 1.

Referring now to FIG. 2, there is shown the hook 1 of FIG. 1 having the ends of flexible strength bearing element 6 passing through the eye 1. The presently preferred up eye hook style is shown here but it is to be understood that a down eye style hook or a ring eye style hook is also suitable for use as the hook 1.

Turning now to FIG. 3, there is shown a fly line attachment element 200 having only an eye 1 and a shank portion 2 the rest of a standard hook having been removed. Additionally, shown is a fly lure weight cone head 8 having a central bore allowing it to be mounted on the hook shank 2 of said fly line attachment element 200, and having a standard fly tying thread 7 attached to said hook shank 2 in known fashion behind the cone head 8. It is to be appreciated that the cone head 8 may be replaced by any known fly lure weight such as, for example, bead heads, dumbbell eyes, and the like. Additionally, it is to be appreciated that in the case of fly lure weights that do not utilize a center bore the weight can be attached after the flexible strength bearing element 6 is permanently mounted to the hook shank 2 of fly line attachment element 200 Likewise, the choice of standard fly tying thread is not critical and can be of any suitable composition and size.

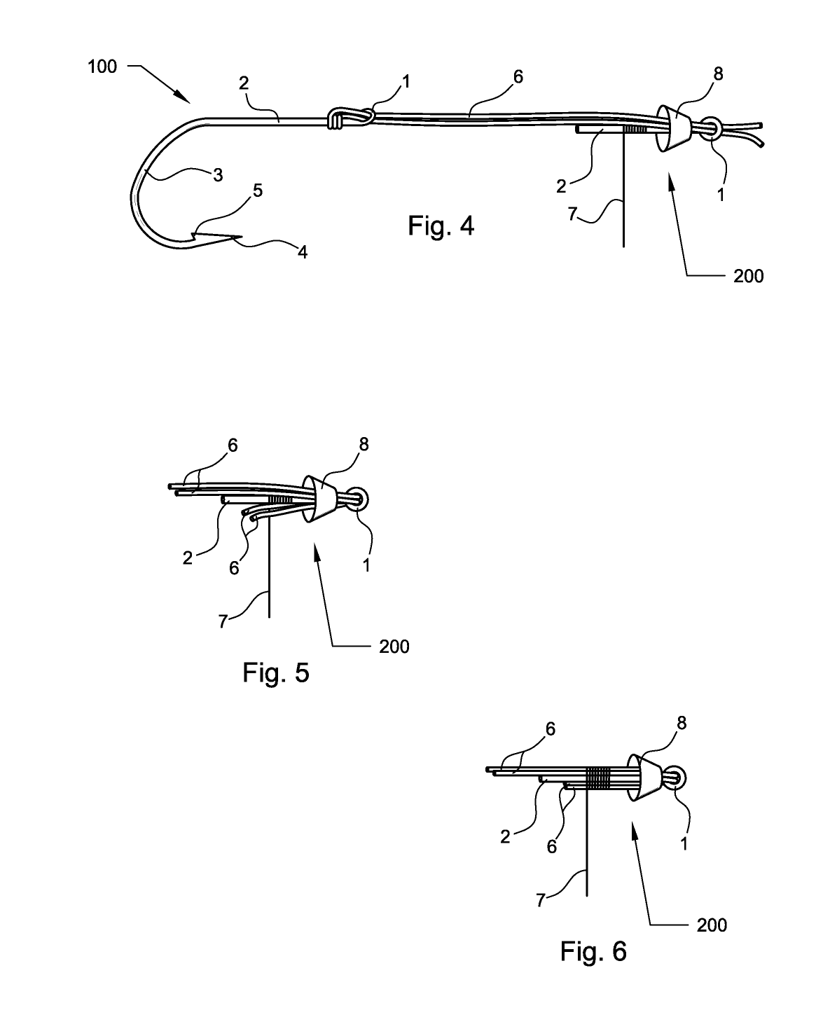

FIG. 4, shows the manner of attaching the hook 100 to the fly line attachment element 200 by the twin strands of flexible strength bearing element 6. Firstly, the desired length of flexible strength bearing element 6 is doubled by wrapping it around the hook shank 2 of a hook 100 in the approximate center of said desired length and the two ends of said desired length of said flexible strength bearing element 6 passing through the eye 1 of said hook 100. Secondly, the two ends of said desired length of flexible strength bearing element 6 are passed through the bore of the cone head weight 8 and then through the eye 1 of fly line attachment element 200. Also shown is attaching means 7 mounted to said fly line attachment element 200 in the form of fly tying thread. The flexible strength bearing element 6 is then pulled through the eye 1 of fly line attachment element 200 until a desired distance between the eye 1 of a hook 100 and the eye 1 of fly line attachment element 200 is realized.

FIGS. 5 and 6 show that once the desired distance between the eyes 1 of a hook 100 and fly line attachment element 200 is realized the ends of flexible strength bearing element 6 are passed through the bore of cone head 8. And the flexible strength bearing element 6 is then permanently secured to the hook shank 2 of fly line attachment element 200 using wraps of fly tying thread 7 as the attaching means. In FIG. 5 the arrow indicates that the cone head weight 8 is pushed forward on the fly line attachment element 200 hook shank 2 until it is against the eye 1 of the fly line attachment element 200.

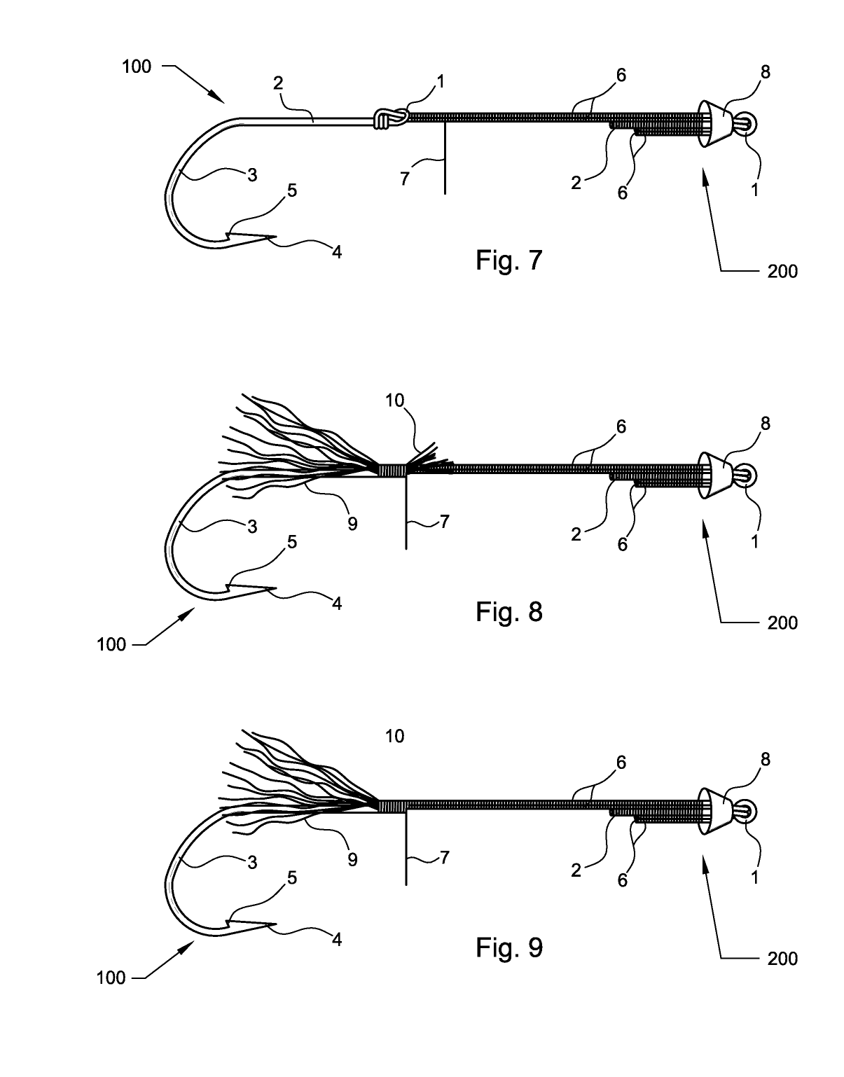

FIG. 7 shows the a hook 100 and fly line attachment element 200 joined by a pair of flexible strength bearing elements 6 with said flexible strength bearing elements 6 permanently fastened by attaching means comprising wraps of fly tying thread 7, said fly tying thread 7 then wound around flexible strength bearing elements 6 rearward to a desired point in front of the eye 1 of a hook 100. The fly tying thread 7 is left hanging at this point from the flexible strength bearing elements 6.

FIGS. 8 and 9 show the permanent mounting of a desired amount of very mobile natural fly tying material 9 to said flexible strength bearing elements 6 by means of fly tying thread 7, in FIG. 8 leaving excess butts 10 exposed, and then in FIG. 9 with the excess butts 10 removed.

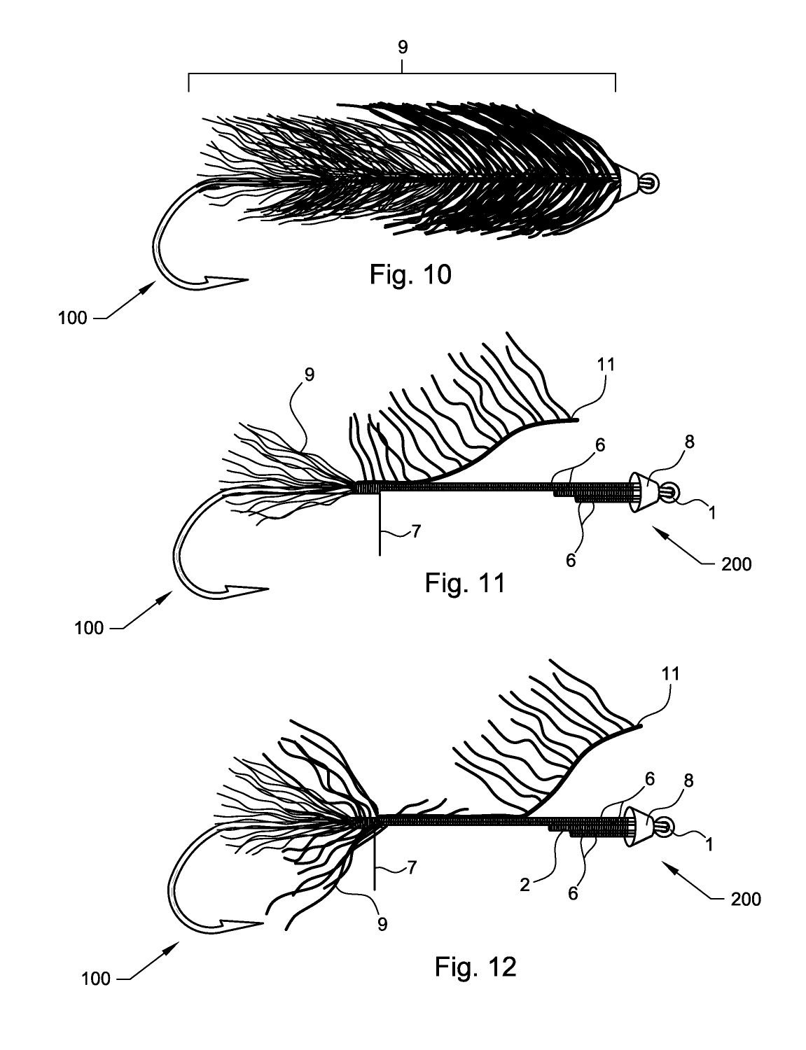

FIG. 10 shows the completed fishing fly lure of one preferred embodiment of the invention wherein a plurality of desired amounts of very mobile natural fly tying materials 9 are mounted on the flexible strength bearing elements 6 between the front of a hook 100 and the rear of cone head 8 mounted behind the eye 1 of fly line attachment element 200.

There is shown in FIG. 11 another preferred embodiment of the present invention wherein a first desired very mobile natural fly tying material 9 is permanently mounted to flexible strength bearing elements 6 in front of a hook 100, a very mobile synthetic fly tying material 11 is permanently mounted on said flexible strength bearing elements 6 by means of wraps of fly tying thread 7 substantially immediately in front of said first desired very mobile natural fly tying material 9. It is to be appreciated that the very mobile synthetic fly tying material of this preferred embodiment comprises filaments bound to a flexible strength bearing element material however, loose filaments of synthetic material be also be utilized and permanently mounted as are the natural materials. Also shown are a hook 100, fly line attachment element 200 having eye 1, hook shank 2, and cone head 8 mounted on hook shank 2.

FIG. 12 shows the embodiment shown in FIG. 11 with a desired amount of very mobile synthetic fly tying material 11 has been wrapped around flexible strength bearing elements 6 and tied off with wraps of fly tying thread 7 and the excess of said very mobile synthetic fly tying material 11 is allowed to lie freely along the flexible cords 6. Again, also shown are a hook 100, fly line attachment element 200 having eye 1 and cone head 8 mounted on hook shank 2.

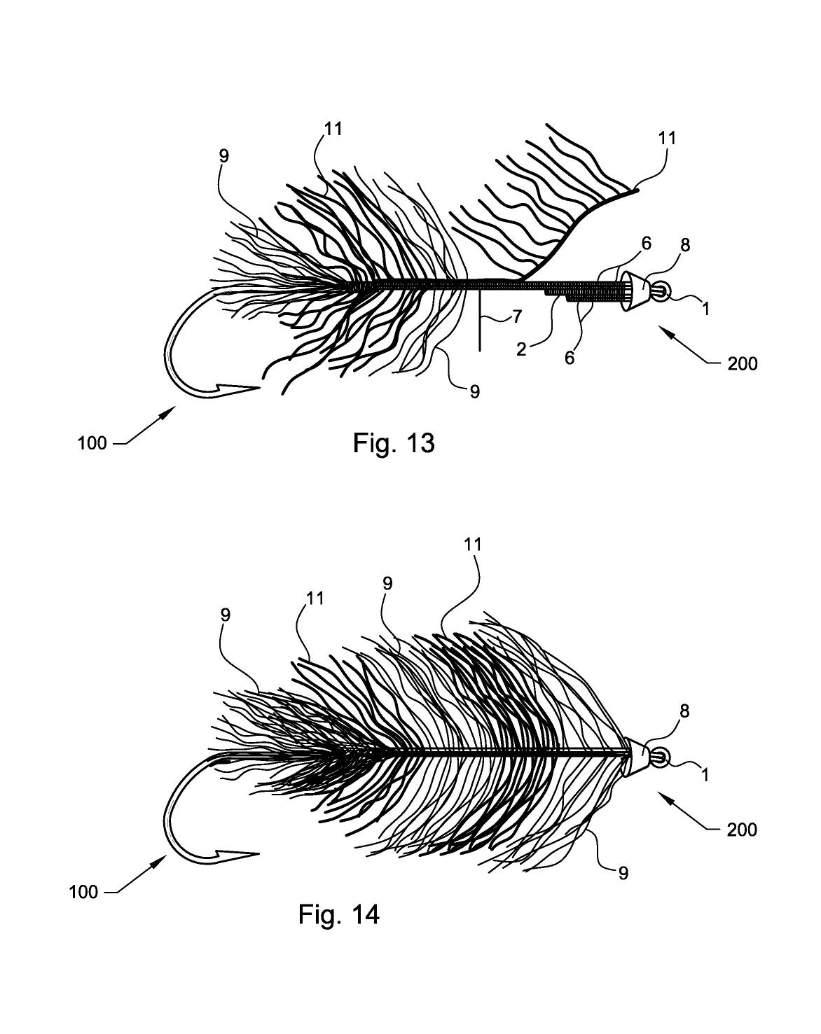

Now in FIG. 13 there is shown the embodiment of the invention first shown in FIG. 11 wherein a second desired amount of the same or different very mobile natural fly tying material 9 has been permanently mounted to said flexible strength bearing elements 6 by attaching means comprising said fly thread 7. Fly tying thread 7 also binding down the very mobile synthetic fly tying material 11 lying along the cords 6 under the second desired amount of very mobile natural fly tying material 9. Also shown are a hook 100, fly line attachment element 200 having eye 1 and cone head 8 mounted on hook shank 2.

FIG. 14 shows the same second embodiment shown in FIGS. 11-13 wherein alternating desired amounts of the same or different very mobile natural fly tying material 9 and very mobile synthetic fly tying material 11 have been permanently mounted to said flexible strength bearing elements 6 by attaching means comprising said fly tying thread 7 to a point slightly behind the rear of the cone head 8 leaving a small amount of space 20 between the rear of said cone head 8 and the front of the last desired amount of very mobile fly tying material 9 or 11. In an embodiment where no weight is mounted on the fly line attachment element 200 shank 2 this space 20 is located behind the eye 1.

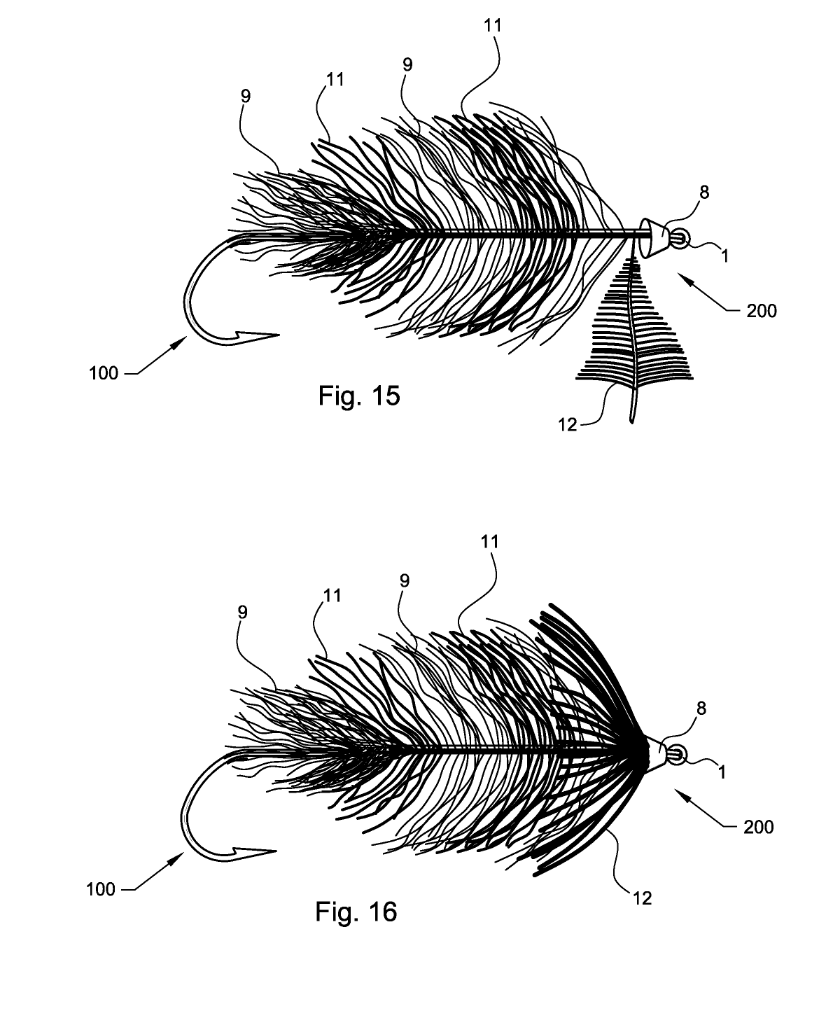

In FIG. 15 a marabou plume or other natural feather 12 is permanently mounted to the shank 2 of fly line attachment element 200 in the space 20 in front of the very mobile materials and behind the hook eye or cone head weight as a complete feather with the stem and fibers intact.

Finally, in FIG. 16 is shown a completed articulated hook fly of this preferred embodiment of the present invention wherein the natural feather 12 has been wrapped or wound around the hook shank 2 of fly line attachment element 200 to fill the space 20 created in the step illustrated in FIG. 14 and permanently mounted with attaching means comprising fly tying thread 7 which is then knotted and the excess cut from the fly resulting in a completed fly of this preferred embodiment of the present invention. Also shown are fly line attachment element 200 hook eye 1 and flexible strength bearing elements 6 passing there through.

One particularly preferred embodiment of the present invention provides for an articulated hook fly wherein the very mobile natural fly tying materials 9 are different colors of marabou fibers stripped free of the feather stem, and the natural feather 12 is a marabou plume feather.

Another particularly preferred embodiment of the present invention provides for an articulated hook fly wherein the very mobile natural fly tying materials 9 are different colors of marabou fibers stripped free of the feather stem, alternating with sections of a mobile synthetic fly tying material 11 and the natural feather 12 is a marabou plume feather.

The flexible strength bearing element 6 suitable for use in the present invention include, for example, gel-spun polyethylene monofilament line, gel-spun polyethylene braided line, braided Dacron line, nylon monofilament line, and braided nylon line. The presently preferred flexible strength bearing element 6 is gel-spun polyethylene monofilament line.

The hook 100 may be any desired hook with an up eye or down eye configuration as are well known in the art. Most preferably the hook 100 has a short shank, i.e., a shank length that is close to the hook gape width as is well known in the art. The fly line attachment element 200 may be any ring eye hook that is of appropriate size onto which to mount the fly lure weight and having an eye interior diameter large enough to accept the passage of the two cords 6 and retain a large enough eye opening to accept a desired size fishing line tippet material.

The very mobile natural fly tying material fibers 9 suitable for use in the present invention may be any mobile natural material fiber free of its natural base hide or stem such as, for example, marabou, Schalppen, ostrich herl, arctic fox fur, cashmere goat fur, rabbit fur, yak hair, Icelandic sheep fur, and the like. Presently preferred very mobile natural fly tying material fiber 9 is turkey marabou fiber.

The very mobile synthetic fly tying materials 11 suitable for use in the present invention include, for example, Mylar tinsel, craft fur, Antron fiber, nylon fiber, polypropylene fiber, and the like. Presently preferred very mobile synthetic fly tying material 11 is fine Mylar tinsel. While loose very mobile synthetic fly tying material fibers are suitable the use of these same fibers bound or twisted into long fibered chenille is also contemplated within the scope of the invention.

The natural feathers 12 suitable for use in the present invention include, for example, marabou plumes, guinea fowl feathers, jungle fowl feathers, Schalppen, and the like. The presently preferred natural feather 12 is marabou plume feathers.

The cone head 8 may be a metal cone head, a plastic cone head, or a metal bead, glass bead, or plastic bead. Presently preferred are metal cone heads particularly tungsten metal cone heads. It is to be understood that while the illustrations all show a cone head 8 the invention may not use any weight element added to the fly at all and still be within the scope of the claimed invention.

Although the preferred embodiments of the present invention has been disclosed, various changes and modifications may be made without departing from the scope of the invention as set forth in the appended claims.

What is claimed is:

1. A fishing lure comprising:
a hook;
a flexible strength bearing element having first and second terminal ends;
means for attaching said hook means to said first terminal end of said flexible strength bearing element;
fly line attachment element having a distal portion for attaching said flexible strength bearing element and a proximal portion for attaching said fishing lure to a fly line;
means for attaching said fly line attachment element to said second terminal end of said flexible strength bearing element; and
a body portion comprising a plurality of free fibers fixedly attached to said flexible strength bearing element and said distal portion of said fly line attachment element by an attachment means and said plurality of free fibers further characterized as being attached substantially completely around and extending radially from said flexible strength bearing element and said distal portion of said fly line attachment element forming a desired body shape.

2. The fishing lure as claimed in claim 1 wherein, said shook is an up-eye hook.

3. The fishing lure as claimed in claim 1 wherein, said hook is a short shank large gape up-eye hook.

4. The fishing lure as claimed in claim 1 wherein, said hook is a ring-eye hook.

5. The fishing lure as claimed in claim 1 wherein, said hook is a down-eye hook.

6. The fishing lure as claimed in claim 1 wherein, said flexible strength bearing element is selected from the group comprising; gel-spun polyethylene monofilament line, gel-spun polyethylene braided line, braided Dacron line, nylon monofilament line, and braided nylon line.

7. The fishing lure as claimed in claim 1 wherein, said plurality of free fibers are natural fibers selected from the group comprising; marabou, Schalppen, ostrich herl, arctic fox fur, cashmere goat fur, rabbit fur, yak hair, Icelandic sheep fur, and silver fox fur.

8. The fishing lure as claimed in claim 1 wherein, said plurality of free fibers are synthetic fibers selected from the group comprising; Mylar tinsel, craft fur, Antron fiber, nylon fiber, and polypropylene fiber.

9. The fishing lure as claimed in claim 1 wherein, said fly line attachment element is a hook having the bend and point removed.

10. The fishing lure as claimed in claim 1 wherein, said fly line attachment element is a cotter pin.

11. A fishing lure comprising:
a hook;
a flexible strength bearing element having first and second terminal ends;
means for attaching said hook to said first terminal end of said flexible strength bearing element;
fly line attachment element having a distal portion for attaching said flexible strength bearing element and a proximal portion for attaching said fishing lure to a fly line;
a weight capable of being mounted on said fly line attachment element;
means for attaching said fly line attachment element to said second terminal end of said flexible strength bearing element; and
a body portion comprising a plurality of free fibers fixedly attached to said flexible strength bearing element and said distal portion of said fly line attachment element by an attachment means and said plurality of free fibers further characterized as being attached substantially completely around and extending radially from said flexible strength bearing element and said distal portion of said fly line attachment element forming a desired body shape.

12. The fishing lure as claimed in claim 1 wherein, said shook is an up-eye hook.

13. The fishing lure as claimed in claim 1 wherein, said hook is a short shank large gape up-eye hook.

14. The fishing lure as claimed in claim 1 wherein, said hook is a down-eye hook.

15. The fishing lure as claimed in claim 1 wherein, said hook is a ring-eye hook.

16. The fishing lure as claimed in claim 1 wherein, said flexible strength bearing element is selected from the group comprising; gel-spun polyethylene monofilament line, gel-spun polyethylene braided line, braided Dacron line, nylon monofilament line, and braided nylon line.

17. The fishing lure as claimed in claim 1 wherein, said plurality of free fibers are natural fibers selected from the group comprising; marabou, Schalppen, ostrich herl, arctic fox fur, cashmere goat fur, rabbit fur, yak hair, Icelandic sheep fur, and silver fox fur.

18. The fishing lure as claimed in claim 1 wherein, said plurality of free fibers are synthetic fibers selected from the group comprising; Mylar tinsel, craft fur, Antron fiber, nylon fiber, and polypropylene fiber.

19. The fishing lure as claimed in claim 1 wherein, said fly line attachment element is a hook having the bend and point removed.

20. The fishing lure as claimed in claim 1 wherein, said weight is selected from the group comprising; metal beads, metal cone heads, glass beads, plastic beads, and plastic cone heads.
